(19) United States
(12) Patent Application Publication
(10) Pub. No.: US 2005/0132603 A1
(43) Pub. Date: Jun. 23, 2005

(54) Dryer

(75) Inventors: Seong Hai Jeong, Changwon-si (KR); Ju Han Yoon, Changwon-si (KR); In Hee Han, Changwon-si (KR); Soo Won Park, Changwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/919,387

(22) Filed: Aug. 17, 2004

(30) Foreign Application Priority Data
Dec. 19, 2003 (KR) P2003-000093862

(51) Int. Cl. F26B 13/10; F26B 19/00

(52) U.S. Cl. 34/603; 34/607

(57) ABSTRACT

A dryer, by which an inlet duct assembly for supplying hot air to a drum holding a drying object therein is facilitated to be assembled, is disclosed. The dryer includes a cabinet, a back cover having an interior side and an exterior side, the exterior side forming a rear side of the cabinet, a supporter, connected to the back cover, for supporting a rearward end of a drum, and an inlet duct assembly for supplying hot air to the drum, wherein the inlet duct assembly includes a rear duct wall integrally formed with the interior side of the back cover, and a front duct wall connected to the rear duct wall to complete the inlet duct assembly.

This application claims the benefit of Korean Application No. P2003-093862, filed on Dec. 19, 2003, which is hereby incorporated by reference.

### BACKGROUND OF THE INVENTION

1. Field of the Invention

The present invention relates to a dryer for drying such an object as clothes, and the like, of which duct assembly for supplying hot air is facilitated to be assembled.

2. Discussion of the Related Art

Generally, a dryer is an apparatus for drying an object in a manner of supplying hot air to the drying object such as wet clothes after washing. A dryer according to a related art consists of a cabinet forming a dryer exterior and a drum provided within the cabinet to hold a drying object therein. The cabinet of the dryer consists of a base, a front plate having a lower end connected to a front end of the base to form a front side of the cabinet, a pair of side plates connected to both ends of a topside of the base to form both lateral sides of the cabinet, respectively, a back cover having a lower end connected to a rear end of the base to form a rear side of the cabinet, and a top plate connected to upper ends of the front plate, side plates, and back cover to form a topside of the cabinet.

A control panel for operating the dryer is provided to an upper part of the front plate. A cabinet opening is formed at a central part of the front plate so that a drying object can be received via the cabinet opening. And, a door is provided to one side of the cabinet opening of the front plate to open/close the cabinet opening. And, the drum is provided within the cabinet to rotate by receiving a drive force of a motor. Moreover, an inlet duct assembly for providing hot air to the drum, a blower forcibly blowing the air, and an exhaust duct assembly connected to the drum to discharge the air are provided to the related dryer. However, in case that a structure of the inlet duct assembly is complicated, it is difficult to assemble the inlet duct assembly. Hence, time and money are excessively needed for the corresponding assembly. And, many efforts are made to the development of a dryer having an inlet duct assembly facilitating its assembly work.

### SUMMARY OF THE INVENTION

Accordingly, the present invention is directed to a dryer that substantially obviates one or more of the problems due to limitations and disadvantages of the related art.

An object of the present invention, which has been devised to solve the foregoing problem, lies in providing a dryer, by which an inlet duct assembly for supplying hot air to a drum holding a drying object therein is facilitated to be assembled.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, a dryer includes a cabinet, a back cover having an interior side and an exterior side, the exterior side forming a rear side of the cabinet, a supporter, connected to the back cover, for supporting a rearward end of a drum, and an inlet duct assembly for supplying hot air to the drum, wherein the inlet duct assembly includes a rear duct wall integrally formed with the interior side of the back cover, and a front duct wall connected to the rear duct wall to complete the inlet duct assembly.

The rear support may have an air inlet through which the hot air of the inlet duct assembly enters the drum. The front duct wall may include an exhaust grill, disposed adjacent the air inlet through which the hot air of the inlet duct assembly enters the drum. The dryer may also include a heater, coupled to the front duct wall, for heating the flowing air. The front duct wall may be coupled to the rear duct wall by screws or by a hook coupling. Herein, the hook coupling may include a plurality of hooks formed at the front duct wall, and a plurality of hook recesses, formed at the rear duct wall, for respectively receiving the hooks.

The back cover may include an intake louver, communicating with the rear duct wall, for drawing in external air. The back cover may also have a recess for receiving the support. The drum may be rotatably provided within the cabinet. The dryer may also include an exhaust duct assembly for guiding air discharged from the drum. The exhaust duct assembly may include a blower for forcibly drawing the air from the drum, and a filter installed adjacent the blower, removing particles from the discharged air. Herein, the back cover has an air outlet through which the discharged air is expelled from the cabinet.

In another aspect of the present invention, a dryer includes a cabinet, a back cover having an interior side and an exterior side, the exterior side forming a rear side of the cabinet, a drum rotatably provided within the cabinet, the drum having open front and rear sides, a rear support having one side connected to the drum and the other side connected to the back cover to support the drum, the rear support connected at the rear side of the drum, the rear support having an air inlet for drawing air into the drum, an inlet duct assembly for supplying hot air to the drum, wherein the inlet duct assembly includes a rear duct wall integrally formed with the interior side of the back cover, and a front duct wall connected to the rear duct wall to complete the inlet duct assembly, and an exhaust duct for guiding air discharged from the drum.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a perspective diagram of a dryer according to one embodiment of the present invention; and

FIG. 2 is a projected perspective diagram of a drum, inlet duct assembly, back cover of a cabinet which are provided to a dryer according to the present invention.

### DETAILED DESCRIPTION OF THE PREFERRED EMBODIMENTS

Reference will now be made in detail to the preferred embodiments of the present invention, examples of which are illustrated in the accompanying drawings. Throughout the drawings, like elements are indicated using the same or similar reference designations where possible.

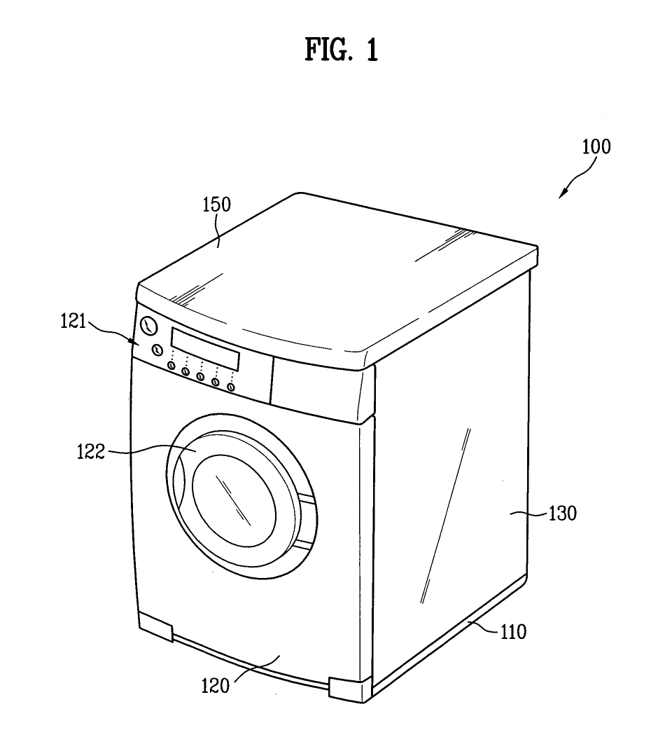

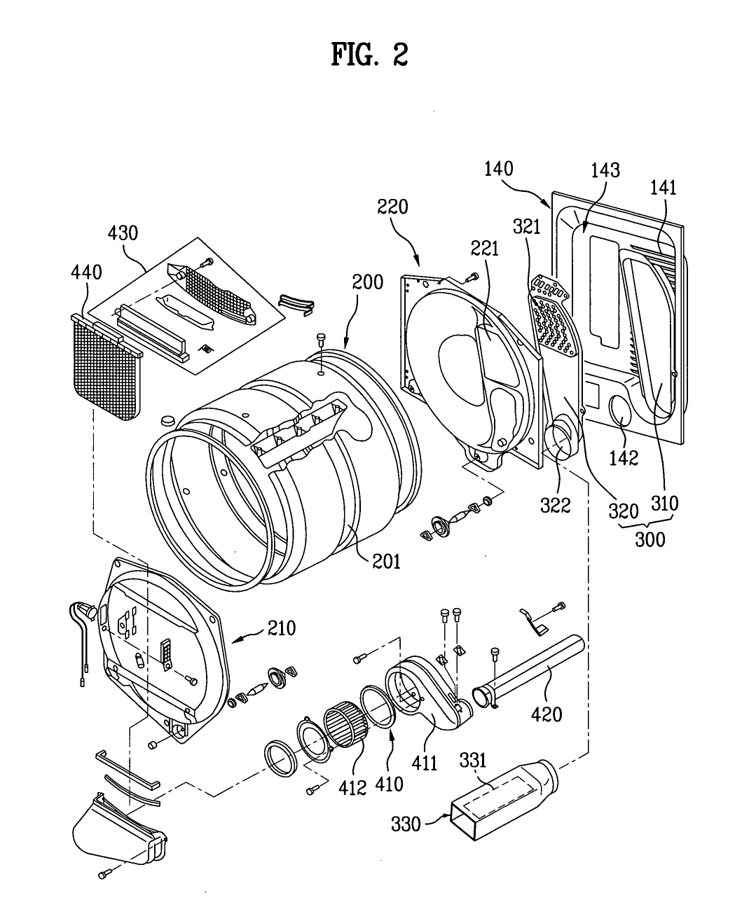

A dryer according to one preferred embodiment of the present invention is explained in detail by referring to FIG. 1 and FIG. 2 as follows. A dryer 100 includes a cabinet forming a dryer exterior and a drum 200 provided within the cabinet to hold a drying object therein. The cabinet of the dryer includes a base 110, a front plate 120 having a lower end connected to a front end of the base 110 to form a front side of the cabinet, a pair of side plates 130 connected to both ends of a topside of the base 110 to form both lateral sides of the cabinet, respectively, a back cover 140 having a lower end connected to a rear end of the base 110 to form a rear side of the cabinet, and a top plate 150 connected to upper ends of the front plate, side plates, and back cover to form a topside of the cabinet.

A control panel 121 for operating the dryer is provided to an upper part of the front plate 120. A cabinet opening (not shown) is formed at a central part of the front plate 120 so that a drying object can be received in the drum 200 via the cabinet opening. And, a door 122 is provided to one side of the cabinet opening of the front plate to open/close the cabinet opening. The drum 200, back cover 140, and inlet duct assembly 300 for supplying hot air to the drum 200, which are provided to the dryer 100 according to the present invention, are explained by referring to FIG. 2 as follows.

Referring to FIG. 2, the drum 200 is rotatably provided within the cabinet. Specifically, the drum 200 has a cylindrical shape of which front and rear sides are open. And, a belt groove 201 is formed on an outer circumference of the drum 200 so that a belt (not shown) connected to a motor is wound on the belt groove 201. A space for holding such a drying object as clothes therein is provided within the drum 200 and a plurality of lifts (not shown) protrude on an inner circumference of the drum 200 in an axial direction. By the above construction, the drying object is caught on the lifts while the drum 200 is rotated. In doing so, the drying object is to be lifted to fall to be turned upside down, thereby enabling to be dried more quickly.

Front and rear supports 210 and 220 are connected to front and rear ends of the drum 200 to cut off the front and rear sides of the drum 200 and to rotatably support the drum 200, respectively. Namely, one side of the rear support 220 is connected to the rear end of the drum 200 to cut off the rear side of the drum 200 and the other side of the rear support 220 is coupled to the back cover 140. And, the air inlet assembly 300 for supplying hot air within the drum 200 is provided between the rear support 220 and the back cover 140. Specifically, the inlet duct assembly 300 includes a rear duct wall 310 built in one body of an inside of the back cover 140 and a front duct wall 320 coupled to a front side of the rear duct wall 310 to supply hot air within the drum 200.

In this case, the front duct wall 320 is coupled to the front side of the rear duct wall 310 by screws (not shown) to be fixed thereto. For this, screw holes are preferably formed on rims of the rear and front duct walls 310 and 320, respectively. Instead, the front duct wall 320 may be coupled to the front side of the rear duct wall 310 by a hook coupling (not shown). In doing so, the hook coupling preferably includes hooks (not shown) formed on a rear end rim of the front duct wall 320 and hook recesses (not shown) for on a front end rim of the rear duct wall 310 to be hooked on the hooks, respectively. On the other hand, the hooks can formed on the front end rim of the rear duct wall 310 when the hook recesses are formed on the rear end rim of the front duct wall 320.

An intake louver 141 sucking external air is provided to a portion of the back cover 140 where the rear duct wall 310 is formed to communicate with the rear duct wall 310. An air outlet 142 communicating with an exhaust duct assembly is formed at the back cover 140, and more particularly, at a lower part of the back cover 140 to discharge air from the cabinet. In addition to the above construction, a recess 143 recessed backward is preferably formed on the back cover 140 so that the rear support 220 is fitted in the recess 143 to be coupled thereto.

The inlet duct assembly 300 is connected to the rear support 220 to supply hot air to the drum 200, thereby enabling to dry the drying object held in the drum 200. For this, an air inlet 221, via which the hot air flows in the drum 200, is formed at an upper part of the rear support 220. An exhaust grill 321, via which the air flows toward the drum 200, is formed at an upper part of the front duct wall 320. And, the exhaust grill 321 is connected to a rear side of the air inlet 221 to communicate with the air inlet 221. A heater case 330 equipped with a heater 331 inside is coupled to the front duct wall 320 at a hot air inlet 322, so that flowing air is heated to supply the hot air to the drum 200.

In the above-constructed dryer 100, the inlet duct assembly 300 and rear support 220 are assembled to the back cover 140 in the following manner. First of all, while the front duct wall 320 is correctly aligned with the rear duct wall 310 built in one body of the back cover 140, the screws are locked in the corresponding screw holes, respectively to couple the front duct wall 320 to the rear duct wall 310 fixedly. Subsequently, the rear support 220 is fixed to the back cover 140 so that the exhaust grill 321 of the front duct wall 320 is connected to the air inlet 221. Meanwhile, the front supporter 210 is fixed to the front plate of the cabinet and rotatably supports the front side of the drum 200.

A front supporter opening is formed at the front supporter 210 to communicate with the cabinet opening to be selectively opened/closed by the door 122. Moreover, an exhaust duct assembly for guiding the air from the drum 200 to the outside of the cabinet is connected to a lower part of the front supporter 210. The exhaust duct assembly includes a blower 410 forcing an air flow and an exhaust duct 420 guiding air to the air outlet 142 of the back cover 140. The blower 410 includes a blower housing 411 and a fan 412 provided within the blower housing 411. And, the fan 412 can be driven by the motor (not shown) for rotating the drum 200. And, the exhaust duct assembly further includes an outlet assembly 430 provided to a portion connected to the front supporter 210 to form an exit for discharging the air from the drum 200 and a filter 440 provided to the outlet assembly 430.

An operation of the dryer 100 according to the present invention is explained as follows. First of all, a drying object such as clothes is put in the drum 200 via the cabinet opening, the door 122 is closed, and the control panel 121 is operated to actuate the dryer 100. The fan 412 of the blower provided to the exhaust duct assembly is rotated by the motor to generate air suction, external air is sucked into the inlet duct assembly 300 via the intake louver 141 of the back cover of the cabinet.

The air sucked into the inlet duct assembly 300 is heated by the heater 331 of the heater case and then flows in the drum 200 via the exhaust grill 321 of the front duct wall and the air inlet 221 of the rear support. In doing so, while the drum 200 is rotated by the motor to dry the drying object well, the hot air having flown in the rotating drum 200 removes water contents from the drying object to flow in the exhaust duct assembly. The air having flown in the exhaust duct assembly is filtered by the filter 440 provided to the outlet assembly 430 to remove particles and then passes through the blower 410 and exhaust duct 420 to be externally discharged.

Accordingly, the dryer according to the present invention has the following advantages or effects. First of all, the rear duct wall constructing the inlet duct assembly is built in one body of the back cover, whereby it is facilitated to assemble the inlet duct assembly and the rear support. Secondly, as the inlet duct assembly is assembled with ease, assembling time and process steps are decreased to reduce product costs and to raise productivity.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

1. A dryer, comprising:
a cabinet;
a back cover having an interior side and an exterior side, the exterior side forming a rear side of the cabinet;
a supporter, connected to the back cover, for supporting a rearward end of a drum; and
an inlet duct assembly for supplying hot air to the drum, wherein the inlet duct assembly comprises:
a rear duct wall integrally formed with the interior side of the back cover; and
a front duct wall connected to the rear duct wall to complete the inlet duct assembly.

2. The dryer of claim 1, wherein the rear support has an air inlet through which the hot air of the inlet duct assembly enters the drum.

3. The dryer of claim 2, wherein the front duct wall comprises an exhaust grill, disposed adjacent the air inlet through which the hot air of the inlet duct assembly enters the drum.

4. The dryer of claim 1, further comprising a heater, coupled to the front duct wall, for heating the flowing air.

5. The dryer of claim 1, wherein the front duct wall is coupled to the rear duct wall by screws.

6. The dryer of claim 1, wherein the front duct wall is coupled to the rear duct wall by a hook coupling.

7. The dryer of claim 6, wherein the hook coupling comprises:
a plurality of hooks formed at the front duct wall; and
a plurality of hook recesses, formed at the rear duct wall, for respectively receiving the hooks.

8. The dryer of claim 1, wherein the back cover comprises an intake louver, communicating with the rear duct wall, for drawing in external air.

9. The dryer of claim 1, wherein the back cover has a recess for receiving the support.

10. The dryer of claim 1, wherein the drum is rotatably provided within the cabinet.

11. The dryer of claim 1, further comprising an exhaust duct assembly for guiding air discharged from the drum.

12. The dryer of claim 11, wherein the exhaust duct assembly comprises:
a blower for forcibly drawing the air from the drum; and
a filter installed adjacent the blower, removing particles from the discharged air.

13. The dryer of claim 12, wherein the back cover has an air outlet through which the discharged air is expelled from the cabinet.

14. A dryer, comprising:
a cabinet;
a back cover having an interior side and an exterior side, the exterior side forming a rear side of the cabinet;
a drum rotatably provided within the cabinet, the drum having open front and rear sides;
a rear support having one side connected to the drum and the other side connected to the back cover to support the drum, the rear support connected at the rear side of the drum, the rear support having an air inlet for drawing air into the drum;
an inlet duct assembly for supplying hot air to the drum, wherein the inlet duct assembly comprises:
a rear duct wall integrally formed with the interior side of the back cover; and
a front duct wall connected to the rear duct wall to complete the inlet duct assembly; and
an exhaust duct for guiding air discharged from the drum.

15. The dryer of claim 14, wherein the front duct wall comprises an exhaust grill, disposed adjacent the air inlet through which the hot air of the inlet duct assembly enters the drum.

16. The dryer of claim 14, wherein the front duct wall is coupled to the rear duct wall by screws.

17. The dryer of claim 14, wherein the front duct wall is coupled to the rear duct wall by a hook coupling.

18. The dryer of claim 17, wherein the hook coupling comprises:
a plurality of hooks formed at the front duct wall; and
a plurality of hook recesses, formed at the rear duct wall, for respectively receiving the hooks.

19. The dryer of claim 14, wherein the back cover comprises:
an intake louver, communicating with the rear duct wall, for drawing in external air; and
an air outlet for expelling from the cabinet the air guided by the exhaust duct assembly.

20. The dryer of claim 14, wherein the back cover has a recess for receiving the rear support.

21. The dryer of claim 14, wherein the exhaust duct assembly comprises:
a blower for forcibly drawing the air from the drum; and
a filter installed adjacent the blower, removing particles from the discharged air.
